(19) United States
(12) Patent Application Publication
(10) Pub. No.: US 2015/0134472 A1
(43) Pub. Date: May 14, 2015

(54) Drag Drop Custom Design Ecommerce

(71) Applicant: Craig Fok, Walnut Creek, CA (US)

(72) Inventor: Craig Fok, Walnut Creek, CA (US)

(21) Appl. No.: 14/077,710

(22) Filed: Nov. 12, 2013

(51) Int. Cl. G06Q 30/06; G06F 3/0482; G06F 3/0486

(52) U.S. Cl. CPC G06Q 30/0621; G06F 3/0486; G06F 3/0482
USPC 705/26.5

(57) ABSTRACT

A computer implemented method and system for internet users to custom design a product by dragging, dropping and moving different (real life like) images of items on a web page thereby forming and completing one product design which the final image is stored as one image to be later used to make and deliver the actual real life product.

### FIELD OF THE INVENTION

The present invention relates to the field of Ecommerce and more particular to a method and system of the process of purchasing items online.

### BACKGROUND

Most all ecommerce websites will display pre-designed products which the internet user can click to purchase. As buying pre-designed products is the most widely accepted method of online purchases, having the option for internet users to customize their own designed products through imagery and interactive means is a new approach that can apply to a variety of industries.

### SUMMARY OF THE INVENTION

The claimed method and system is for internet users to custom design a product by dragging, dropping and moving different images of items, particularly items that look like real life products, on a web page thereby forming and completing the product design which the final image is stored as one image to be later used to make the actual real life product. The internet user can also rotate the images clockwise or counter-clockwise. Once the final design is saved, the one image is then stored into the website's database which the users can retrieve or edit the design at a later time before finalizing the purchase. Each item will have different prices and when the design is finalized, all the item prices will be added up for the total final price.

Once the internet user's design is completed with the delivery information provided and the full order paid, the final designed product image and delivery information will be forwarded by email, via the website system, to designated people who will make the real designed product according to the final designed product. The finished product will then be delivered to the delivery address provided by the internet user.

### BRIEF DESCRIPTION OF THE DRAWINGS

A general architecture that implements various features of specific embodiments of the invention will now be described with reference to the drawings. The drawings and the associated descriptions are provided to illustrate embodiments of the invention and not to limit the scope of the invention. Throughout the drawings, reference numbers are used to indicate correspondence between referenced elements.

FIG. 1 is a flow chart illustrating the process of the present invention.

FIG. 2 is an example of the website which the internet user can move, drag and drop items to create a custom design.

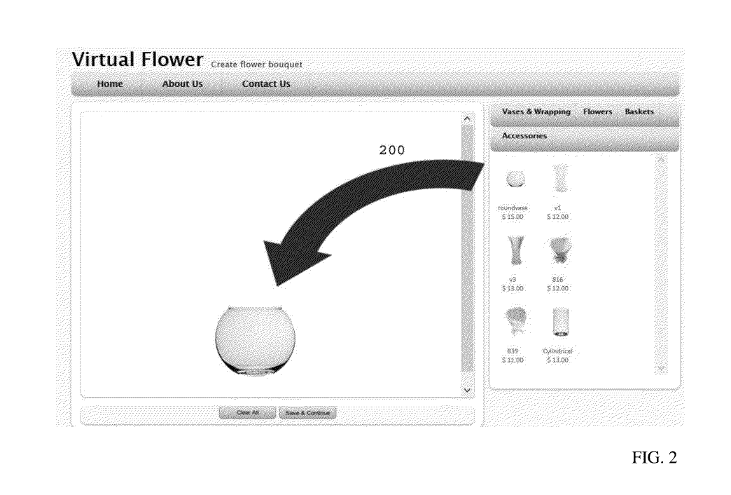

FIG. 3 is an example of moving multiple items before forming the final design.

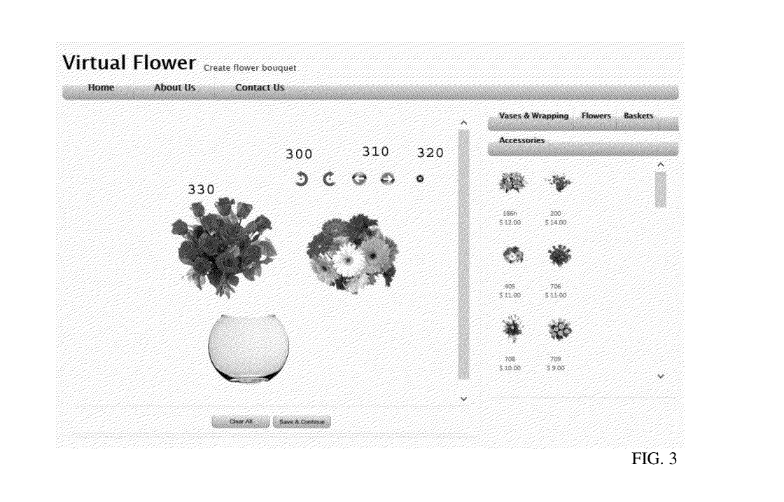

FIG. 4 is an example of rotating an item clockwise or counter-clockwise. Also the item can be deleted or removed from the design.

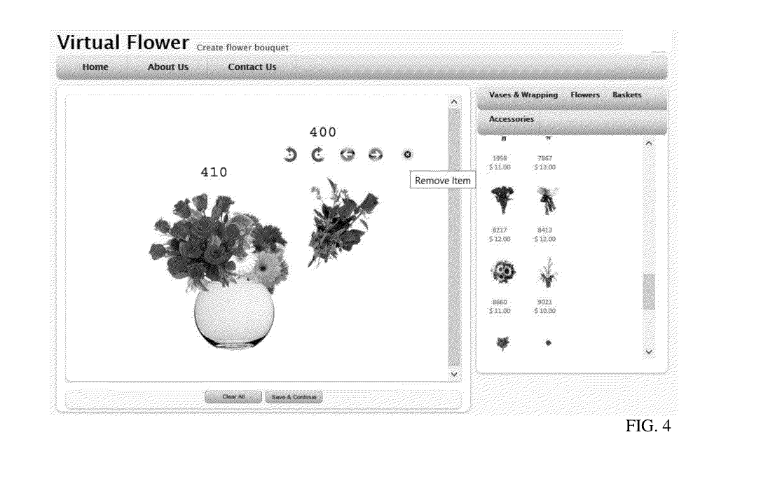

FIG. 5 is an example of finishing the designed product as well as moving multiple items to the design area for a final order purchase. Upon the final purchase, all items that are in the custom design will be added up for a total purchase price.

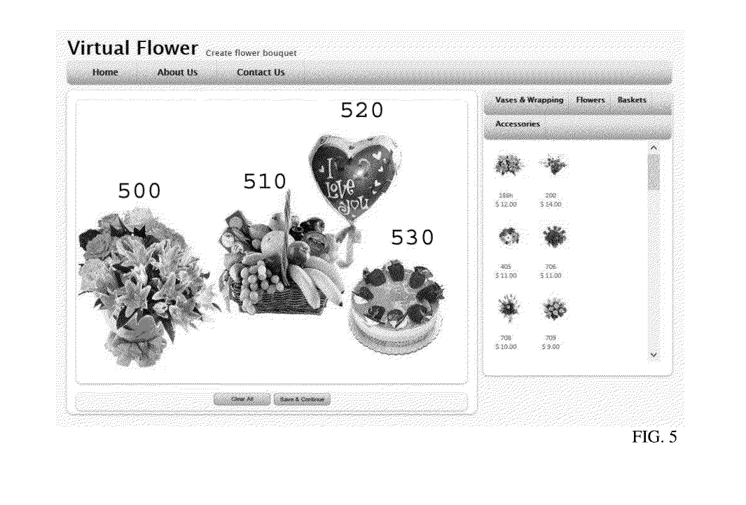

### OBJECTIVES OF THE INVENTION

The objective of the present invention is to allow the internet user to custom make their own design by moving, dragging and dropping items from a given menu which multiple images and products are then combined into one image to be made and delivered.

### DETAILED DESCRIPTION OF THE INVENTION

The computer-implemented system and method is for internet users to custom design a product by dragging, dropping and moving different images of items on a web page thereby forming and completing the product design which the final image is stored as one image to be later used to make the actual real life product.

The internet user can also rotate the images clock-wise or counter clock-wise.

Once the final design is saved, the one image is then stored into the website's database which the users can retrieve or edit the design at a later time before finalizing the purchase. Each item will have different prices and when the design is finalized, all the item prices will be added up for the total final price.

Once the internet user's design is completed with the delivery information provided and the full order paid, the final designed product image and delivery information will be forwarded by email, via the website system, to designated people who will make the real designed product according to the final designed product. The finished product will then be delivered to the delivery address provided by the internet user.

This invention relates to an internet service. The current invention uses Internet communications tool, browser, ISP (Internet Service Providers), embedded website, URL, protocols and languages that are known to one skilled in the art and therefore not disclosed here in detail. The method of which the items in the web page is moved is not limited to only clicking down the mouse but also includes finger tapping on mobile devices.

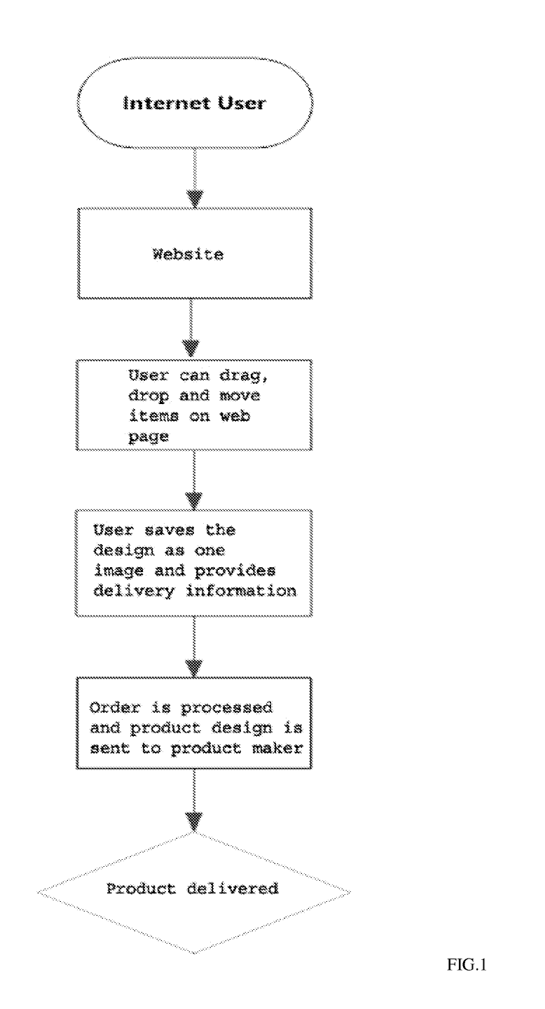

FIG. 1 illustrates the process of the general method of customizing a product which is to be made and delivered.

The user can drag 200 over the item from the provided given menu on the right to the design area on the left. The red arrow only demonstrates the direction of how the item is moved over from right to left by dragging and dropping the item.

The item image can be hovered over to show the different controls of the image.

The controls include rotating the image clockwise or counter-clockwise 300, 400.

The image can also be moved forward or back 310, in front of or behind 410 other images. The image can also be removed 320 from the final design. Multiple items 330 can be moved into the design to create one final image and product.

The final design can consist of multiple items 500, 510, 520, 530. These multiple images are combined into one image which is then later sent to people who make the actual product and have it delivered to the internet user's designated delivery address.

### Operation

The Internet user uses a computer or mobile device to connect to the Internet to access the website and web pages. The web and application server(s) use standard SQL queries to read and write data to a database server. Emails and email notifications are sent through the web and application servers. The technology is based on scripts and codes within the website page allowing the user to be able to move images to form a design, combine multiple images into one image which upon the finalization of the design, the order is sent out with the one image and delivery details to designated people who make and deliver the actual product.

### Advantages

The primary advantage of this system is to allow internet users to customize their own (real life like) designed product through interactive methods and have the actual (real) product delivered to the internet user's designated delivery address.

By being able to customize the design, the internet user is given more flexibility in ordering products online. This system also allows a wide number of design combination which can be done on one web page versus a large number of pages needed when having pre-designed products.

### Conclusion, Ramifications, and Scope

This system can help internet businesses provide more options and flexibility for internet users to visually customize and design their product. Internet user benefits also include being able to simplify their ordering process through less website pages and a quicker process to finalize their purchase. Internet users also will have better control over the final design and result of the product they order.

What is claimed:

1. A computer implemented method and system for internet users to custom design a product by dragging, dropping and moving different images of items on a web page thereby forming and completing one final product design which the final image is stored as one image to be later used to make the actual real life product.

2. The system of claim 1, wherein said system is a computer implemented method utilizing the internet. The computer implemented method is also included in mobile technology and apps.

3. The system of claim 1, wherein the said internet user can move around items on the web page by clicking on the items in a given menu and dragging the items onto an area on the web page to form a final design created from multiple items. The word “clicking” is not limited to only the computer mouse but also includes finger tapping on mobile devices and mobile technology.

4. The system of claim 1, wherein the said internet user can at any time rotate the items clockwise or counter-clockwise, move the items in front or back of other items or delete the items during the process of creating the design.

5. The system of claim 1, wherein the internet user can save the final design and proceed to purchase the final design. Once the final design is saved, the one image is then stored into the website's database which the users can retrieve or edit the design at a later time before finalizing the purchase. Each item will have different prices and when the design is finalized, all the item prices will be added up into one total final price.

6. The system of claim 1, wherein once the internet user's final design is completed with the delivery information provided and the full order paid, the final designed product image and delivery information will be forwarded by email, via the website system, to designated people who will make the real designed product according to the final designed product. The finished product will then be delivered to the delivery address provided by the internet user.
